(19) United States
(12) Patent Application Publication
(10) Pub. No.: US 2025/0267537 A1
(43) Pub. Date: Aug. 21, 2025

(54) METHOD AND APPARATUS FOR PROCESSING RADIO RESOURCE CONTROL MESSAGES

(71) Applicant: Nokia Technologies Oy, Espoo (FI)

(72) Inventors: Jani-Pekka KAINULAINEN, Cambridge (GB); Riikka Karoliina DIMNIK, Espoo (FI); Lars DALSGAARD, Oulu (FI); Xin ZHANG, Munich (DE)

(21) Appl. No.: 19/056,073

(22) Filed: Feb. 18, 2025

(30) Foreign Application Priority Data
Feb. 19, 2024 (GB) 2402299.8

(51) Int. Cl. H04W 36/04; H04W 36/08; H04W 74/0833; H04W 76/20

(52) U.S. Cl. CPC H04W 36/04; H04W 36/08; H04W 74/0833; H04W 76/20

(57) ABSTRACT

There is herein disclosed an apparatus, comprising means for receiving, by a user equipment, a radio resource control (RRC) configuration message associated with a Layer 1/Layer 2 (L1/L2) triggered mobility (LTM) procedure. The apparatus further comprises means for determining that the user equipment is able to process at least an LTM related part of the RRC configuration message prior to applying the configuration associated with the received cell switch command for performing a cell switch. The apparatus further comprises means for determining that a trigger for the user equipment to perform the processing of the LTM related part of the RRC configuration message has been activated and means for performing, upon the determination that the trigger for the user equipment to commence processing has been activated, the processing of the LTM related part of the received RRC configuration message within a predefined time.

### CROSS REFERENCE

The present application claims priority to UK Patent Application No. 2402299.8, filed Feb. 19, 2024, entitled “Method and Apparatus for Processing Radio Resource Control Messages”, the contents of which are incorporated by reference herein in their entirety.

### FIELD

The present application relates to an apparatus, method and computer program. In particular, but not exclusively, the present application relates to managing lower layer triggered mobility in a communication system.

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communication sessions may comprise, for example, communication of data for carrying communications such as voice, video, electronic mail (email), text message, multimedia and/or content data and so on. Non-limiting examples of services provided comprise two-way or multi-way calls, data communication or multimedia services and access to a data network system, such as the Internet.

The communication system and associated devices typically operate in accordance with a given standard or specification which sets out what the various entities associated with the system are permitted to do and how that should be achieved. Communication protocols and/or parameters which shall be used for the connection are also typically defined. One example of a communications system is UTRAN (3G radio). Other examples of communication systems are the long-term evolution (LTE) of the Universal Mobile Telecommunications System (UMTS) radio-access technology and so-called 5G or New Radio (NR) networks. NR is being standardized by the 3rd Generation Partnership Project (3GPP).

There is a desire to reduce the delays associated with a handover procedures in communication systems, such as Layer 3 (L3) handover procedure.

### SUMMARY

The scope of protection sought for various embodiments of the invention is set out by the independent claims. The embodiments and features, if any, described in this specification that do not fall under the scope of the independent claims are to be interpreted as examples useful for understanding various embodiments of the invention.

According to a first aspect, there is described an apparatus comprising means for: receiving, by a user equipment, a radio resource control (RRC) reconfiguration message associated with a Layer 1/Layer 2 (L1/L2) triggered mobility (LTM) procedure; determining that the user equipment is able to process at least an LTM related part of the RRC configuration message prior to applying the configuration associated with the received cell switch command for performing a cell switch; determining that a trigger for the user equipment to perform the processing of the LTM related part of the RRC configuration message has been activated; and performing, upon the determination that the trigger for the user equipment to commence processing has been activated, the processing of the LTM related part of the received RRC configuration message within a predefined time.

The apparatus may optionally further comprise means for receiving, from a network node, a cell switch command for performing a cell switch from a source cell to a target cell; and means for performing a cell switch from the source cell to the target cell.

The processing of at least part of the L1/L2 LTM procedure may comprise Abstract Syntax Notation One (ASN.1) validation and/or decoding.

The trigger may represent the start time for commencing the processing of the LTM related part of the received RRC configuration message, and the processing of the LTM related part of the received RRC configuration message may be completed at the user equipment after a processing time.

The trigger for the user equipment to commence the processing of the LTM related part of the RRC configuration message may comprise: the receipt, at the user equipment, of the RRC configuration message associated with the L1/L2 LTM procedure; or the transmission, from the user equipment, of an RRC configuration complete message associated with the L1/L2 LTM procedure.

The trigger for the user equipment to commence the processing of the LTM related part of the RRC configuration message may relate to at least one element of a transmission configuration information (TCI) state activation procedure.

The trigger for the user equipment to commence the processing of the LTM related part of the RRC configuration message may comprise the receipt, at the user equipment, of a transmission configuration information (TCI) state activation medium access control (MAC) control element (CE) message; or the transmission, from the user equipment, of an acknowledgement of the transmission configuration information (TCI) state activation medium access control (MAC) control element (CE) message; or the transmission, from the user equipment, of an acknowledgement of the transmission configuration information (TCI) state activation medium access control (MAC) control element (CE) message in addition to a processing delay; or the completion of a transmission configuration information (TCI) state activation.

The means for performing, means for performing the processing of the LTM related part of the received RRC configuration message, may comprise performing the processing of only for the candidate cell(s) for a TCI state to be activated.

The trigger for the user equipment to commence the processing of the LTM related part of the RRC configuration message may relate to at least one element of a physical downlink control channel (PDCCH) ordered random access channel (RACH) procedure.

The trigger for the user equipment to commence the processing of the LTM related part of the RRC configuration message may comprise: the receipt, at the user equipment, of a downlink control information (DCI) command; or the completion of the physical downlink control channel (PDCCH) ordered random access channel (RACH) procedure.

The apparatus may optionally further comprise means for transmitting, to a network node, an indication that the processing of at least part of the L1/L2 LTM related part of the received RRC configuration message has been completed.

The transmission of the indication that the processing has been completed may be sent at a predetermined time.

The apparatus may comprise the user equipment.

According to a second aspect, there is described means for: transmitting, by a network node of a radio access network to a user equipment, a radio resource control (RRC) reconfiguration message associated with a Layer 1/Layer 2 (L1/L2) triggered mobility (LTM) procedure; determining that a trigger for the user equipment to commence the processing of the LTM related part of the RRC configuration message has been activated, wherein the user equipment performs, upon the trigger for the user equipment to commence processing has been activated, the processing of the LTM related part of the received RRC configuration message; determining that processing of the LTM related part of the RRC configuration message is complete, based on the determining that the trigger has been activated and a processing time has passed.

The apparatus may further comprise means for transmitting, from a network node to the user equipment, a cell switch command for performing a cell switch from a source cell to a target cell.

The processing of at least part of the L1/L2 LTM procedure may comprise Abstract Syntax Notation One (ASN.1) validation and/or decoding.

The trigger may represent the start time for commencing the processing of the LTM related part of the received RRC configuration message, and the processing of the LTM related part of the received RRC configuration message may be completed at the user equipment after a processing time.

The trigger for the user equipment to commence the processing of the LTM related part of the RRC configuration message may comprise: the receipt, at the user equipment, of the RRC configuration message associated with the L1/L2 LTM procedure; or the transmission, from the user equipment, of an RRC configuration complete message associated with the L1/L2 LTM procedure.

The trigger for the user equipment to commence the processing of the LTM related part of the RRC configuration message may relate to at least one element of a transmission configuration information (TCI) state activation procedure.

The trigger for the user equipment to commence the processing of the LTM related part of the RRC configuration message may comprise the receipt, at the user equipment, of a transmission configuration information (TCI) state activation medium access control (MAC) control element (CE) message; or the transmission, from the user equipment, of an acknowledgement of the transmission configuration information (TCI) state activation medium access control (MAC) control element (CE) message; or the transmission, from the user equipment, of an acknowledgement of the transmission configuration information (TCI) state activation medium access control (MAC) control element (CE) message in addition to a processing delay; or the completion of a transmission configuration information (TCI) state activation.

The means for performing, means for performing the processing of the LTM related part of the received RRC configuration message, may comprise performing the processing of only for the candidate cell(s) for a TCI state to be activated.

The trigger for the user equipment to commence the processing of the LTM related part of the RRC configuration message may relate to at least one element of a physical downlink control channel (PDCCH) ordered random access channel (RACH) procedure.

The trigger for the user equipment to commence the processing of the LTM related part of the RRC configuration message may comprise: the receipt, at the user equipment, of a downlink control information (DCI) command; or the completion of the physical downlink control channel (PDCCH) ordered random access channel (RACH) procedure.

The apparatus may further comprise means for receiving, from the user equipment, an indication that the processing of at least part of the L1/L2 LTM related part of the received RRC configuration message has been completed.

The transmission of the indication that the processing has been completed may be sent at a predetermined time.

The apparatus may comprise the network node of the radio access network.

According to a third aspect, there is described a method comprising: receiving, by a user equipment, a radio resource control (RRC) reconfiguration message associated with a Layer 1/Layer 2 (L1/L2) triggered mobility (LTM) procedure; determining that the user equipment is able to process at least an LTM related part of the RRC configuration message prior to applying the configuration associated with the received cell switch command for performing a cell switch; determining that a trigger for the user equipment to perform the processing of the LTM related part of the RRC configuration message has been activated; and performing, upon the determination that the trigger for the user equipment to commence processing has been activated, the processing of the LTM related part of the received RRC configuration message.

According to a fourth aspect, there is described a method comprising: transmitting, by a network node of a radio access network to a user equipment, a radio resource control (RRC) reconfiguration message associated with a Layer 1/Layer 2 (L1/L2) triggered mobility (LTM) procedure; determining that a trigger for the user equipment to commence the processing of the LTM related part of the RRC configuration message has been activated, wherein the user equipment performs, upon the trigger for the user equipment to commence processing has been activated, the processing of the LTM related part of the received RRC configuration message; determining that processing of the LTM related part of the RRC configuration message is complete, based on the determining that the trigger has been activated and a processing time has passed.

According to a fifth aspect, there is provided a computer program product comprising a set of instructions which, when executed on an apparatus, is configured to cause the apparatus to carry out the method of any preceding method definition.

According to a sixth aspect, there is provided a non-transitory computer readable medium comprising program instructions stored thereon for performing the method of any preceding method definition.

### BRIEF DESCRIPTION OF THE DRAWINGS

Example embodiments will now be described by way of non-limiting example, with reference to the accompanying drawings, in which:

FIG. 1 illustrates an example of a split access node architecture;

FIG. 2 illustrates an example of components of a 5G New Radio (NR) network topology

FIG. 3 illustrates an example of an apparatus configured to practice one or more example embodiments;

FIG. 4A and FIG. 4B illustrates a signalling diagram of a process for managing LTM in a 5G system;

FIG. 5 illustrates an example of delays associated with a Layer 3 (L3) handover procedure;

FIG. 6 illustrates a block diagram of a method for managing LTM in a 5G system performed by a user equipment;

FIG. 7 illustrates a TCI activation scenario;

FIG. 8 illustrates a MAC CE cell switch scenario;

FIGS. 9A-9C illustrates a signalling diagram of a process for managing LTM in a 5G system;

FIG. 10. shows a block diagram of a method for managing LTM in a 5G system performed by a network node.

### DETAILED DESCRIPTION

Reference will now be made in detail to example embodiments, examples of which are illustrated in the accompanying drawings. The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

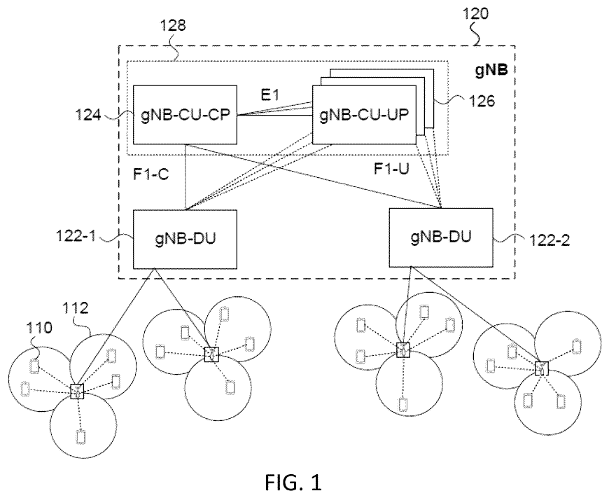

A UE may connect to different cells of a network and use L1 and/or L2 signalling to perform mobility (handover) procedures between the cells, for example intra-DU (distributed unit or distributed node) or inter-DU cell switch within a single central unit (CU) of an access node. In L1/L2 triggered mobility, a medium access control (MAC) control element (CE) or downlink control information (DCI) may trigger the cell switch. L1 measurements may be used at execution phase of the cell switch. Such procedure may be referred to as L1/L2 mobility. Example embodiments of the present disclosure may provide mechanisms and procedures for L1/L2-based inter-cell mobility that enable reduction of latency in L1/L2 triggered mobility (LTM), enable configuration and maintenance for multiple candidate cells to allow fast application of configurations for candidate cells, provide a dynamic switch mechanism among candidate serving cells (including special cells, SpCell, and secondary cells, SCell) for applicable scenarios based on L1/L2 signalling, provide L1 enhancements for inter-cell beam management (e.g., including L1 measurement and reporting and/or beam indication), and enable timing advance management, provide central unit (CU)/distributed unit (DU) interface signaling to support LTM. Distribution of processing of an access node to a CU and one or more DUs is described with reference to FIG. 1. The described procedures of L1/L2-based inter-cell mobility may be applicable to the following scenarios:
standalone, carrier aggregation (CA), or 5G new radio (NR) dual connectivity (NR-DC) with serving cell change within one configured grant (CG),
intra-DU case and intra-CU inter-DU case (applicable for standalone and CA),
both intra-frequency and inter-frequency mobility,
both Frequency Range 1 (FR1) and Frequency Range 2 (FR2), or
source and target cells being synchronized or non-synchronized.

Embodiments of the present disclosure enable to reduce the handover (inter-cell mobility) latency, for example in the scenarios described above. In L1/L2 triggered mobility (LTM), a UE may be configured to report L1 beam measurements to a serving DU (source DU). Based on the L1 beam measurements the serving DU may decide when to trigger the handover. This enables to simplify many of the network and UE mobility procedures as well as reduce the interruption time or delay caused by the mobility. Furthermore, network data forwarding and scheduling may also benefit from LTM. In LTM, the UE may maintain configuration of multiple cells to enable fast application of each configuration. LTM may involve serving cell change or not, and it can use either the random-access channel (RACH) or be RACH-less.

In LTM, the serving DU may trigger execution of a prepared target cell configuration based on lower layer (L1/L2) signalling, which may for example include a medium access control (MAC) control element (CE) or downlink control information (DCI). Upon triggering the cell change, the serving DU may inform the CU, which may terminate sending any radio resource control (RRC) reconfiguration messages over the serving cell radio link and initiate data forwarding to the target cell.

LTM may use L1 measurements. These measurements have the benefit of faster reaction time to radio link degradation in the serving link, for example because the network can save the delay introduced by Layer 3 (L3) filtering and a time-to-trigger (TTT) delay for the handover decision. This enables to reduce the number of radio link failures compared to non-L1/L2 based handover.

FIG. 1 illustrates an example of a split access node architecture. An access node, represented throughout the description by gNB 120, may be split, functionally and/or physically, to a central unit (CU) 128 and one or more distributed units (DU), in this example two DUs 122-1 and 122-2. CU 128 may be also referred to as gNB-CU and DU(s) be also referred to as gNB-DU(s). CU 128 may comprise control plane (CP) and user plane (UP) entities, represented by gNB-CU-CP 124 and gNB-CU-UP 126, respectively. The gNB-CU-CP 124 may be configured to control communication of signalling data that enables transfer of user/application data at the user plane. User plane communications may be provided by one or more gNB-CU-UPs 126 associated with gNB-CU-CP 124. CU 128 and DU(s) 122-1, 122-2 may be configured to provide radio access network (RAN) services to device(s), represented by user equipment (UE) 110, at one or more cells 112.

Control and user plane entities of CU 128 may communicate via a communication interface, such as for example an E1 interface. CU 128 may communicate with a DU over a communication interface, such as for example an F1 interface. The F1 interface may comprise control and user plane interfaces (F1-C, F1-U) between a DU and the control and user plane entities of CU 128, respectively. Even though two DUs are illustrated in FIG. 1, a CU may be in general associated with one or a plurality of DUs.

The CU/DU-split architecture enables disaggregation of the RAN, thus enabling operators to utilize different vendors for different network nodes, but also to enable network vendors to split their network implementations for scalability purposes. For example, control and user planes may be separated to their own entities, thereby enabling control and user plane functions to be dimensioned separately. The split may be however (almost) invisible to a user equipment (UE) and therefore, at the UE side, the protocol layers may be (mostly) unaware of the split, except for minor parts which the UE may implicitly determine from the associated radio resource control RRC configuration. In case of intra- or inter-DU handover, the network may be configured to explicitly control which part of the protocol stack is reconfigured. This may be included in the RRC processing and therefore the RRC delay may be variable, or static but with different delays for different scenarios.

A UE 110 may access application services via the RAN, which may comprise one or more gNBs 120. UE 110 may communicate with gNB 120 over a radio interface, configured for example based on the 5G NR (New Radio) standard defined by the 3rd Generation Partnership Project (3GPP). Communication network 100 may therefore comprise a wireless communication network.

Communication network 100 may be operated based on a protocol stack comprising a plurality of protocol layers. The protocol stack may be arranged based on the open systems interconnection (OSI) model or a layer model of a particular standard (e.g., a 3GPP standard). In one example, the protocol stack may comprise a service data adaptation protocol (SDAP) layer, which may receive data from an application layer for transmission. The SDAP layer may be configured to exchange data with a packet data convergence (PDCP) layer. The PDCP layer may be responsible of generation of data bursts comprising one or more data packets, for example based on data obtained from the SDAP layer.

The PDCP layer may provide data to one or more instances of a radio link control (RLC) layer. For example, PDCP data may be transmitted on one or more RLC transmission legs. Each RLC instance may be associated with corresponding MAC instances of a MAC layer (Layer 2). The MAC layer may provide a mapping between logical channels of upper layer(s) and transport channels of the physical layer, handle multiplexing and demultiplexing of MAC service data units (SDU). Furthermore, the MAC layer may provide error correction functionality based on packet retransmissions, for example according to the hybrid automatic repeat request (HARQ) process. Physically separate transmission legs may be provided by the physical (PHY) layer, also known as Layer 1 (L1). The RLC, MAC, and L1 functionality may reside on DU(s) 122-1, 122-2. Corresponding protocol stacks may be applied both at gNB 120 and UE 110.

In a split access node architecture, part of the protocol layers may be implemented at CU 128. In the example of FIG. 1, CU 128 (e.g., CU UP 126) may be configured to handle upper layers of the protocol stack, for example SDAP and PDCP layers. Furthermore, CU 128 (e.g., CU-CP 124) may be configured to handle radio resource control (RRC) operations. DU(s) 122-1, 122-2 may be configured to handle lower layers of the protocol stack, for example RLC, MAC, and L1. A user plane (U-plane) control function may interact with the MAC layer to encapsulate RRC data received from CU-CP 124 in MAC packets and/or decapsulate RRC data from MAC packets and provide the RRC data to CU-CP 124. Radio unit(s) of the DU(s) 122-1, 122-2 may transmit/receive data to/from UE(s) over a radio interface.

As noted above, one CU may include, or be configured to control, several DUs. Furthermore, one DU may serve multiple cells, for example tens of cells. Providing the RRC layer in CU 128 may enable good control of mobility of UE 110 and also enable it to operate as a central resource manager for UE 110. DUs 122-1, 122-2 may include a resource manager that controls lower layer radio parameter usage, e.g., periodical physical uplink control channel (PUCCH) resources, and also some central computing unit (CPU) computing resources.

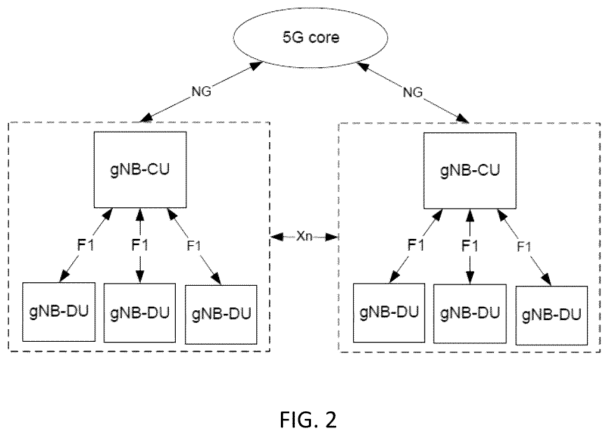

Communication network 100 may comprise other network function(s), network device(s), or protocol(s), in addition, or alternative to, those mentioned above. Even though some embodiments have been described in the context of 5G network, it is appreciated that embodiments of the present disclosure are not limited to this example network. Example embodiments may be therefore applied in any present or future communication networks. An apparatus may comprise, or be configured to implement, e.g. by means of software, one or more of the protocol layers described herein. FIG. 2 illustrates an example of components of a 5G New Radio (NR) network topology. As user equipment (UE) moves through a wireless communication system, it may move through regions of radio coverage (cells) supported by one or more radio access network node. Maintaining an ability for UE to communicate effectively with the wireless communication system as it moves through regions of radio coverage is typically referred to as mobility. The operational characteristics of cells supported by network access nodes within a wireless communication network may differ. The wireless communication system may comprise various Transmission and Reception Points (TRPs).

It is envisaged that multiple transmission and reception points mTRPs may be used in a 5G NR network to improve reliability, coverage and capacity performance through flexible deployment scenarios. Multi-TRP operates to alleviate intercell interference via dynamic coordination between multi TRPs to provide joint scheduling and transmission/reception. Wireless devices, such as UEs at a cell edge may be served by multi TRPs to improve signal transmission and/or reception, resulting in increased throughput. The following description may provide further details of alternatives, modifications and variances in a 5G NR network: a gNB may comprise, e.g., a node providing NR user plane and control plane protocol terminations towards UE 110, and connected via the NG interface to the 5GC, e.g., according to 3GPP TS 38.300 V16.6.0 (3021-06) section 3.2 incorporated herein by reference.

A gNB Central Unit (gNB-CU) comprises e.g. a logical node hosting e.g. RRC (radio resource control), SDAP (service data adaptation protocol) and PDCP (packet data convergence protocol) protocols of the gNB or RRC and PDCP protocols of the en-gNB that controls the operation of one or more gNB-DUs. The gNB-CU terminates the F1 interface connected with the gNB-DU.

A gNB Distributed Unit (gNB-DU) comprises e.g. a logical node hosting e.g. RLC (radio link control), MAC (medium access control) and PHY (physical) layers of the gNB or en-gNB, and its operation is partly controlled by the gNB-CU. One gNB-DU supports one or multiple cells. One cell may be supported by only one gNB-DU. The gNB-DU terminates the F1 interface connected with the gNB-CU.

A gNB-CU-Control Plane (gNB-CU-CP) comprises e.g. a logical node hosting e.g. the RRC and the control plane part of the PDCP protocol of the gNB-CU for an en-gNB or a gNB. The gNB-CU-CP terminates the E1 interface connected with the gNB-CU-UP and the F1-C interface connected with the gNB-DU.

A gNB-CU-User Plane (gNB-CU-UP) comprises e.g. a logical node hosting e.g. the user plane part of the PDCP protocol of the gNB-CU for an en-gNB, and the user plane part of the PDCP protocol and the SDAP protocol of the gNB-CU for a gNB. The gNB-CU-UP terminates the E1 interface connected with the gNB-CU-CP and the F1-U interface connected with the gNB-DU, e.g. according to 3GPP TS 38.501 V16.6.0 (3021-07) section 3.1 incorporated by reference.

Different functional splits between the central and distributed unit are possible, e.g. called options:

Option A (1A-like split): The function split in this option is similar to the 1A architecture in DC. RRC is in the central unit. PDCP, RLC, MAC, physical layer and RF are in the distributed unit.

Option B (3C-like split): The function split in this option is similar to the 3C architecture in DC. RRC and PDCP are in the central unit. RLC, MAC, physical layer and RF are in the distributed unit.

Option C (intra RLC split): Low RLC (partial function of RLC), MAC, physical layer and RF are in the distributed unit. PDCP and high RLC (the other partial function of RLC) are in the central unit.

Option D (RLC-MAC split): MAC, physical layer and RF are in the distributed unit. PDCP and RLC are in the central unit.

Or else, e.g. according to 3GPP TR 38.801 V14.0.0 (2017-03) section 11 incorporated herein by reference.

A gNB may support different protocol layers, e.g. Layer 1 (L1)-physical layer. The layer 2 (L2) of NR is split into the following sublayers: Medium Access Control (MAC), Radio Link Control (RLC), Packet Data Convergence Protocol (PDCP) and Service Data Adaptation Protocol (SDAP), where e.g.: The physical layer offers to the MAC sublayer transport channels; The MAC sublayer offers to the RLC sublayer logical channels; The RLC sublayer offers to the PDCP sublayer RLC channels; The PDCP sublayer offers to the SDAP sublayer radio bearers; The SDAP sublayer offers to 5GC QoS flows; Comp. may refer to header compression and Segm. to segmentation; Control channels include (BCCH, PCCH). Layer 3 (L3) includes e.g. Radio Resource Control (RRC), e.g. according to 3GPP TS 38.300 V16.6.0 (3021-06) section 6 incorporated herein by reference.

A RAN (Radio Access Network) node or network node or central node or distributed node like e.g. a gNB, base station, gNB CU or gNB DU or parts thereof may be implemented using e.g. an apparatus with at least one processor and/or at least one memory (with computer-readable instructions (computer program)) configured to support and/or provision and/or process CU and/or DU related functionality and/or features, and/or at least one protocol (sub-) layer of a RAN (Radio Access Network), e.g. layer 2 and/or layer 3. They may also be implemented using specific means configured to perform respective specific tasks, e.g. layer 3 means to perform layer 3 operations, layer 2 means to perform layer 2 operations, etc. A central node may e.g. implement CU-CP and/or CP-UP functionality.

The gNB CU and gNB DU parts may e.g. be co-located or physically separated. The gNB DU may even be split further, e.g. into two parts, e.g. one including processing equipment and one including an antenna. A Central Unit (CU) may also be called BBU/REC/RCC/C-RAN/V-RAN, O-RAN, or part thereof. A Distributed Unit (DU) may also be called RRH/RRU/RE/RU, or part thereof.

A gNB-DU supports one or multiple cells, and could thus serve as e.g. a serving cell for a user equipment (UE).

In other words: A 5G base station or “network node” named gNB can be divided into two physical entities named CU (Centralized Unit) and DU (Distributed Unit).

CU provides support for the higher layers of the protocol stack such as SDAP, PDCP and RRC (and in particular layer 3 protocol like RRC) while DU provides support for the lower layers of the protocol stack such as RLC, MAC and Physical layer (in particular layer 1 like Physical layer and layer 2 protocol like RLC and MAC). Also, note that SDAP layer will not be present if the CU is connected to a 4G Core because 5G core network is needed to support SDAP. There may be a single CU for each gNB, but one CU may control multiple DUs, for example more than 100 DUs can be connected to one CU.

Each DU is able to support one or more cells, so one gNB can control hundreds of cells unlike a 4G base station. Also, note that the interface between CU and DU is named F1 and as per 3GPP, it should be an open interface, to be able to connect one CU from one vendor to a DU from a different vendor.

A user equipment (UE) may include a wireless or mobile device, an apparatus with a radio interface to interact with a RAN (Radio Access Network), a smartphone, an in-vehicle apparatus, an IoT device, a M2M device, or else. Such UE or apparatus may comprise: at least one processor; and at least one memory including computer program code; wherein the at least one memory and the computer program code are configured to, with the at least one processor, cause the apparatus at least to perform certain operations, like e.g. RRC connection to the RAN. A UE is e.g. configured to generate a message (e.g. including a cell ID) to be transmitted via radio towards a RAN (e.g. to reach and communicate with a serving cell). A UE may generate and transmit and receive RRC messages containing one or more RRC PDUs (Packet Data Units).

The UE may have different states (e.g. according to 3GPP TS 38.331 V16.5.0 (3021-06) sections 42.1 and 4.4).

A UE is e.g. either in RRC_CONNECTED state or in RRC_INACTIVE state when an RRC connection has been established.

In RRC_CONNECTED state a UE may: store the AS context; transfer unicast data to/from the UE; monitor control channels associated with the shared data channel to determine if data is scheduled for the data channel; provide channel quality and feedback information; and/or perform neighbouring cell measurements and measurement reporting.

The RRC protocol includes e.g. the following main functions: RRC connection control; measurement configuration and reporting; establishment/modification/release of measurement configuration (e.g. intra-frequency, inter-frequency and inter-RAT measurements); setup and release of measurement gaps; and/or measurement reporting.

As networks have developed, and particularly in 5G New Radio (NR) systems, rather than being controlled by the core network, inter-cell mobility is implemented such that it is configured to be layer 1 (L1 or PHY layer) or layer 2 (L2 or MAC layer) centric (L1/L2-centric). Within the 5G NR framework, various methodologies to implement L1/L2-centric inter-cell mobility are possible, and may be selected based upon varying operational scenarios as described further below.

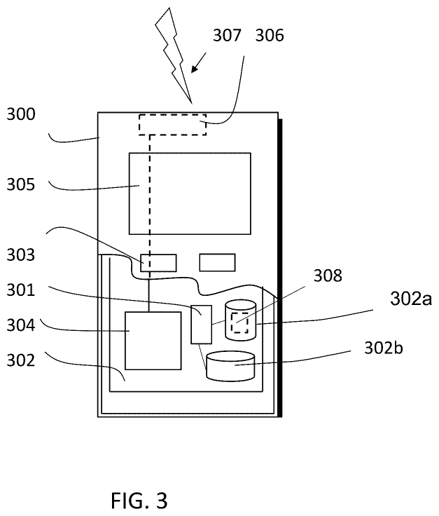

FIG. 3 illustrates an example of a UE 300, such as the UE illustrated on FIG. 1. The UE 300 may be provided by any device capable of sending and receiving radio signals. Non-limiting examples comprise a user equipment, a mobile station (MS) or mobile device such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, a Cellular Internet of things (CIT) device or any combinations of these or the like. The UE 300 may provide, for example, communication of data for carrying communications. The communications may be one or more of voice, electronic mail (email), text message, multimedia, data, machine data and so on.

The UE 300 may receive signals over an air or radio interface 307 via appropriate apparatus for receiving and may transmit signals via appropriate apparatus for transmitting radio signals. In FIG. 3 transceiver apparatus is designated schematically by block 306. The transceiver apparatus 306 may be provided for example by means of a radio part and associated antenna arrangement. The antenna arrangement may be arranged internally or externally to the mobile device.

The UE 300 may be provided with at least one processor 301, at least one memory ROM 302a, at least one RAM 302b and other possible components 303 for use in software and hardware aided execution of tasks it is designed to perform, including control of access to and communications with access systems and other communication devices. The at least one processor 301 is coupled to the RAM 302b and the ROM 302a. The at least one processor 301 may be configured to execute an appropriate software code 308. The software code 308 may for example allow to perform one or more of the present aspects. The software code 308 may be stored in the ROM 302a.

The processor, storage and other relevant control apparatus can be provided on an appropriate circuit board and/or in chipsets. This feature is denoted by reference 304. The device may optionally have a user interface such as keypad 305, touch sensitive screen or pad, combinations thereof or the like. Optionally one or more of a display, a speaker and a microphone may be provided depending on the type of the device.

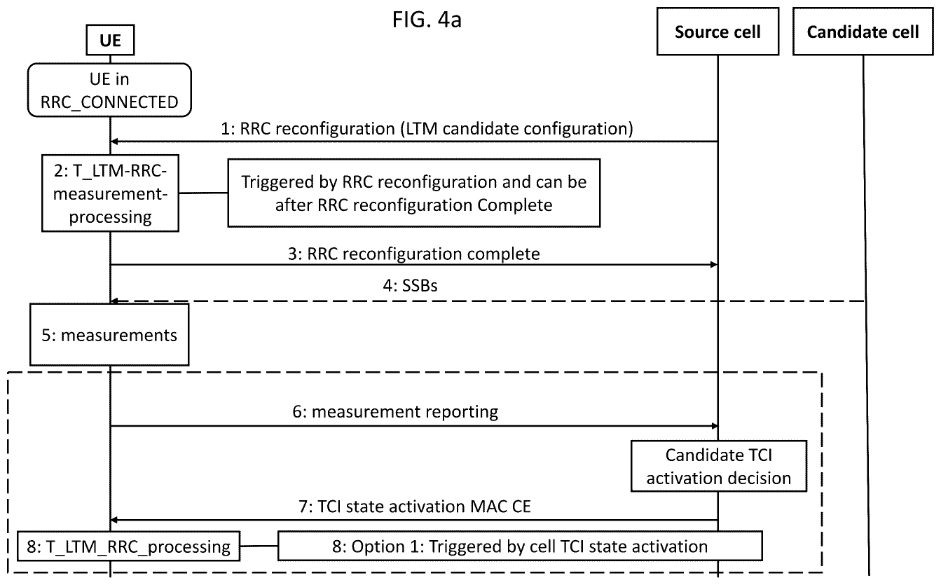

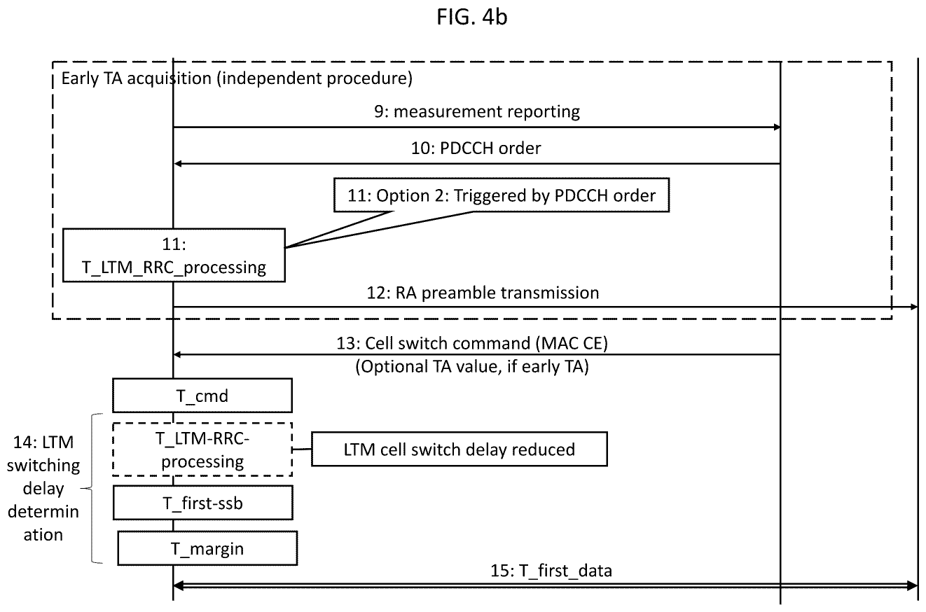

FIG. 4A and FIG. 4B show a signalling diagram of a process for LTM in a 5GS. Initially, a UE may be served by a source cell provided by a network node (e.g. gNB). The UE may be in an RRC connected state. The UE may perform at least one of layer 1, layer 2 or layer 3 measurements of the source cell and other detected cells, for example possible candidate cells. For example, the layer 1 measurements may comprise synchronization signal block (SSB) measurements and/or channel state information (CSI) reference signal (RS) measurements. The UE may perform layer 3 measurements of the source cell based on the layer 1 measurements of the source cell.

The UE may transmit, to the gNB on the source cell, a report comprising result of at least one the layer 1, the layer 2, or layer 3 measurements of the source cell.

In step 1, the UE may receive, from the gNB on the source cell, a RRC configuration message comprising RRC configurations for candidate cells. For example, the gNB may select the one or more candidate cells based on at least one of the layer 1, layer 2, or layer 3 measurements of the candidate cells performed by the UE based on a previous RRC configuration message. The RRC configuration message may comprises at least one of first configuration information or second configuration information.

In step 2, the UE may extract and decode the first configuration information of the candidate cells. The UE may not be required to perform RRC ASN.1 validation for the second configuration at the moment. The UE will extract and decode the second configuration information for the candidate cells, when the UE receives a triggering message or indication. The UE may also select not to decode full second configuration, but only resolve it partially. For example UE may resolve the second configuration to identify the configuration association to the identifiers candidate cells. That is, the UE may partially extract and decode the RRC configurations in step 2.

In step 3, the UE may transmit, on the source cell, a RRC configuration complete message.

It will be understood that the order of step 2 and step 3 may be reversed.

In step 4, the UE may receive, on the one or more selected candidate cells, synchronisation signal blocks (SSBs).

In step 5, the UE may perform at least one of layer 1, layer 2, or layer 3 measurements of the candidate cells by using the first configuration information.

In step 6, the UE may transmit, on the source cell, a measurement report comprising result of the at least one layer 1, layer 2 or layer 3 measurements of the candidate cells. The gNB may determine that TCI states for some or all of the candidate cells are to be added to a list of active TCI states stored at the UE.

In step 7, the UE may receive, on the source cell, a MAC CE comprising a request to add TCI states for some or all of the candidate cells to the list of active TCI states stored at the UE. The request may comprise cell identifiers for some or all of the candidate cells. The request may be the TCI state activation MAC CE.

In step 8, the UE may extract and decode the second configuration information for some or all of the candidate cells the TCI state of which was added to the list of active TCI states. The UE performs LTM RRC processing with the second configuration information in advance i.e. before the cell switch command. By doing this, the UE does not need to do the LTM_RRC_processing procedure when the UE performs the cell switching to the target cell and the cell switch delay is able to be reduced.

Alternatively, in step 9, the UE may transmit, on the source cell, a measurement report comprising results of at least one of the layer 1, layer 2 or layer 3 measurements of the candidate cells.

In step 10, the UE may receive, on the source cell, a physical downlink control channel (PDCCH) signal causing the UE to perform random access procedure for acquiring timing advance (TA) for one or more candidate cells. The PDCCH signal may cause the UE to transmit a random access (RA) preamble on a PRACH of one or more of the candidate cells. The PDCCH signal also causes the UE to perform the LTM RRC processing in advance by using the second configuration information. The LTM RRC processing may be either directly after the PDCCH signal reception, or it may be after UE has performed the PRACH preamble transmission successfully.

In step 11, the UE may extract and decode the second configuration information for the one or more candidate cells. The one or more candidate cells may be decided based on the measurements in step 5.

In step 12, the UE may transmit, on a PRACH of one or more of the candidate cells, an RA preamble.

Steps 6 to 8 are performed for candidate TCI state activation procedure and steps 9 to 12 are performed for the early TA acquisition procedure. Steps 6 to 8 and steps 9 to 12 are independent of each other. The UE may perform the LTM RRC processing by using the second configuration information when the UE receives the trigger at step 7 or step 9. The trigger for performing the LTM RRC processing may be one or both of the TCI state activation MAC CE or the PDCCH signal.

In step 13, the UE may receive, on the source cell, a MAC CE comprising a command to switch the UE from the source cell to a target cell. The target cell may be selected by the gNB amongst the candidate cells based on at least one of the layer 1, layer 2, or layer 3 measurements for the candidate cells received in step 6 or in step 9.

If the UE receives the cell switch command, then the UE performs the cell switching from the source cell to the target cell. For performing the cell switching, the UE may calculate the cell switch delay.

Step 14 represents the UE cell switch delay DLTM for the cell switching procedure. The LTM switch delay DLTM may be the delay from the end of the last TTI containing the MAC CE command for cell switch until the UE transmits the first UL message on the target cell. In order to determine the delay, there is a need to determine the values (e.g., components) including at least one of T_{cmd}, T_{LTM-RRC-processing}, T_{LTM-processing}, T_{first-ssb}, T, and/or T_{RS-proc}. However, the UE has already performed the LTM RRC processing at step 8 or 11, thus the UE does not need the T_{LTM-RRC-processing} value anymore during the cell switching procedure. By doing this, the cell switching delay can be reduced at the cell switching procedure. The calculation will be explained in detail below. For example, the UE may calculate the delay DLTM to transmit on the target cell from the end of the transmission time interval (TTI) comprising the MAC CE with the command to switch the UE from the source cell to the target cell.

The UE may be allowed to transmit or receive data or control information on the target cell within the delay DLTM. The UE may not be allowed to transmit on the target cell within the delay DLTM. The delay DLTM may be referred to as a cell switch delay.

Transmission on the target cell may comprise transmitting data or control information on a physical uplink shared channel (PUSCH) or physical uplink control channel (PUCCH) of the target cell, and reception on the target cell may comprise receiving data or control information on a physical downlink shared channel (PDSCH) or physical downlink control channel (PDCCH). Transmitting on the target cell may comprise transmitting a RA preamble on a PRACH of the target cell.

The delay D_{LTM} may be expressed in step 14 as follows:

$${D}_{LTM} = {T}_{c m d} + {T}_{LTM - interrupt}$$

$${T}_{{LTM}^{-} i n t e r r u p t} = {T}_{LTM - RRC - processing} + {T}_{LTM - processing} + {T}_{first - SSB} + {T}_{margin} + {T}_{LTM - IU} .$$

The delay D_{LTM} may comprise a component T_{cmd} accounting for transmitting, on the source cell, an acknowledgement of the reception of the command to switch the UE from the source cell to the target cell. The component T_{cmd} may be equal to T_{HARQ}+3 ms, where T_{HARQ} is the time between receiving the command to switch the UE from the source cell to the target cell and transmitting the acknowledgement (e.g. as specified in 3GPP TS 38.213). The component T_{cmd} may be expressed as follows:

$${T}_{c m d} = {T}_{HARQ} + 3 {N}_{slot}^{subframe , μ}$$

The delay D_{LTM} may comprise a component T_{LTM-RRC-processing} accounting for decoding the second configuration information for the target cell subsequent to receiving the command to switch the UE from the source cell to the target cell. If the second configuration information for the target cell has been decoded in step 8 or step 11 prior to receiving the command to switch the UE from the source cell to the target cell in step 13, the component T_{LTM-RRC-processing} may be set to a zero value. If the second configuration information for the target cell has not been decoded in step 8 or step 11 prior to receiving the command to switch the UE from the source cell to the target cell in step 13, the component T_{LTM-RRC-processing} processing may be set to a non-zero value. The non-zero value may be a default value (e.g. up to 10 ms).

The delay D_{LTM} may comprise a component T_{LTM-processing} accounting for applying the second configuration information for the target cell.

The delay D_{LTM} may comprise a component T_{first-Rs} accounting for time tracking and acquiring timing information for the target cell. In some cases, for example if the TCI state of the target cell is in the list of active TCI states stored by the UE, the component T_{first-Rs} may be set to a zero value. In other cases, for example if the TCI state of the target cell is not in the list of active TCI states stored by the UE, the component T_{first-Rs} may be set to a non-zero value. The non-zero value may account for a time between receiving the command to switch the UE from the source cell to the target cell and receiving a first SSB on the target cell. The non-zero value may be a default value (e.g. up to 160 ms). In some cases, T_{first-Rs} may also refer to the first transmission of another reference signal, such as TRS (transmission reference signal).

The delay D_{LTM} may comprise a component T_{RS-proc} accounting for UE processing time of the reference signal (e.g. SSB) measured in T_{first-RS}. The component T_{SSB-proc} may be set to a non-zero value. The non-zero value may be a default value (e.g. up to 2 ms).

The delay D_{LTM} may comprise a component T_{LTM-IU} accounting for waiting for a resource to transmit on the target cell. If the UE performs a RACH procedure with the target cell, the component T_{LTM-IU} may account for waiting for a PRACH resource to transmit a RA preamble on the target cell. The component T_{LTM-IU} may be up to the summation of a SSB to PRACH resource associated period (e.g. specified in table 8.1-1 of 3GPP TS 38.213) and a non-zero value. The non-zero value may be a default value (e.g. up to 160 ms).

If the UE does not perform a RACH procedure with the target cell, the component T_{LTM-IU} may account for waiting for a PUSCH or PUCCH resource to transmit a data or control on the target cell. The UE may switch from the source cell to the target cell. The UE may transmit, on the target cell, within the delay D_{LTM}.

It will be understood that aspects relating to the decoding of the second configuration information for the candidate cells in step 8 or in step 11 may be specified in the standards.

It will be understood that aspects relating to the delay D_{LTM} may be specified in the standards. For example, 3GPP TS 38.133 may include the following clauses.

### 6.X.1.2 LTM Cell Switch Delay

LTM cell switch delay D_{LTM} is the delay from the end of the last TTI containing the MAC-CE command for cell switch until the time the UE transmits the first UL message on the target cell, where:

$${D}_{L T M} = {T}_{c m d} + {T}_{L T {M}^{-} interrupt} ,$$

### Where

T_{cmd} equals to T_{HARQ}+3 ms, where T_{HARQ} is the timing between cell switch command and acknowledgement as specified in TS 38.213
T_{LTM-interrupt} is as stated in section 6.X.1.2.1.

### 6.X.1.2.1 Interruption Time

The interruption time is the time between end of the last TTI containing the MAC-CE command for cell switch until the time the UE transmits the first UL message on the target cell, excluding T_{cmd} and T_{LTM-RRC-processing} stated in section 6.X.1.2.

$${T}_{L T {M}^{-} interrupt} = + {T}_{LTM - RRC - processing} + {T}_{{LTM}^{-} processing} + {T}_{first - RS} + {T}_{margin} + {T}_{{LTM}^{-} IU} m s$$

T_{LTM-RRC-processing} is the time for UE decoding and validity check for the RRC configuration of the target cell. T_{LTM-RRC-processing}=0 if the UE has performed early decoding and early validity check of the complete LTM candidate cell configuration according to TS 38.331 prior to the cell switch command for the target cell indicated in the cell switch command, otherwise T_{LTM-RRC-processing}=[10] ms.
   T_{LTM-RRC-processing}=0 after PDCCH order has been performed before the cell switch command
   T_{LTM-RRC-processing}=0 after candidate cell TCI state activation has been performed before the cell switch command

It will be understood that decoding the second configuration information for the candidate cells in step 8 or in step 11 may be based on a UE capability. The UE capability may comprise a UE capability to decode the second configuration information for the candidate cells in step 8 or in step 11, that is a UE capability to decode the second configuration information for the candidate cells “early” (e.g., before receiving the command to switch from the source cell to the target cell in step 13). The UE capability may comprise a UE capability to decode the second configuration information for a single candidate cell. The UE capability may comprise a UE capability to decode the second configuration information for multiple candidate cells. For example, the UE may be capable of storing multiple TCI states for multiple candidate cells in the list of active TCI states. The UE may be capable of storing N TCI states for N candidate cells in the list of active TCI states, wherein the N TCI states for the for N candidate cells are the last N TCI states added by the UE to list of active TCI states. The UE capability may or may not be known by the gNB. For example, the UE may transmit, to the gNB on the source cell, information explicitly or implicitly indicating the UE capability.

It will be understood that one or more of steps 1 to 13 may be optional (e.g. redundant) and therefore may be omitted. It will be understood that, whilst steps 1 to 13 have been illustrated in a single signaling diagram, each of steps 1 to 13 may be part of a single implementation. One or more of steps 1 to 13 may be redundant or optional as explained above. One or more of steps 1 to 13 may be omitted to form different implementations.

It will be understood that, in the above, the source cell and the candidate cells may be served by the same gNB (i.e. intra-BS switch) or by another gNB (i.e. inter-BS switch). For example, the source cell and the at least one candidate cell are controlled by the serving gNB, or the source cell is controlled by the serving gNB and the at least one candidate cell is controlled by another gNB or gNBs.

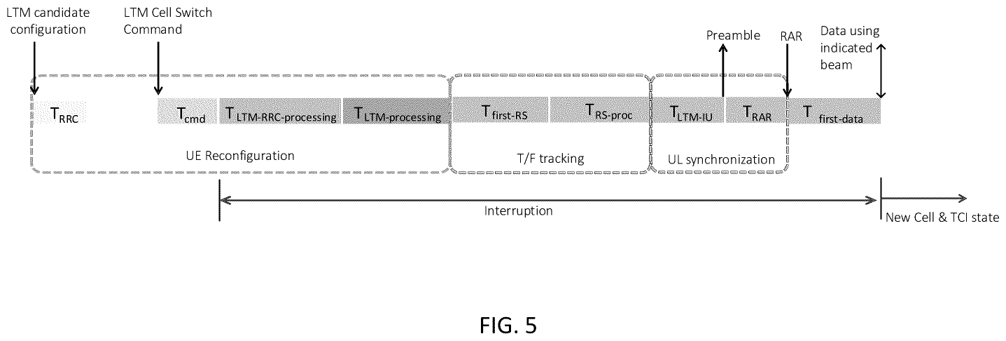

FIG. 5 illustrates an example of delays associated with a Layer 3 (L3) handover procedure. UE 110 may receive a candidate configuration indicative of one or more handover target cells. The terms mentioned in the FIG. 5 may have the following meanings:
T_{RRC} Processing time for RRCReconfiguration carrying candidate configurations
T_{cmd} Time for processing L1/L2-command (HARQ and parsing)·
T_{LTM-RRC-processing} Early ASN.1 decoding and validity/compliance check
T_{LTM-Processing} UE processing including applying target cell parameters and L1/L2 change.
T_{first-Rs} Time for fine tracking and acquiring full timing information
T_{RS-proc} Time for SSB processing.
T_{LTM-IU} Interruption uncertainty in acquiring the first UL transmission
T_{RAR} Time for RAR delay
T_{first-data} Time for UE performs the first DL/UL reception/transmission on the indicated beam of the target cell, after RAR

Furthermore, there are many ways UEs can process the RRC configuration. Some UEs may be able to process the full RRC configuration upon receiving it, but others may just validate the configuration and process it later. Therefore, some handover requirements may be designed based on the worst case scenario. This may not be optimal for LTM that aims to reduce the processing delay.

UE LTM RRC processing may include a decoding and validation/compliance check. Based on the LTM UL indication, the network may determine that UE 110 has performed a syntax notation check and/or a compliance check for the RRC configuration, for example an ASN.1 (Abstract Syntax Notation One) validity and/or compliance check. UE 110 may determine to perform this either once it receives the command or once the cell switch command is received. UE 110 may generally not provide information to the network on whether the command processing happens before or after the switch command. Therefore, UE requirements may be again designed based on the worst case scenario.

Example embodiments of the present disclosure provide methods to reduce the service interruption time related to RRC processing in L1/L2 triggered handover. This may be achieved by addressing how the RRC data is processed at UE 110. UE 110 may indicate its RRC processing capability to the network, for example by explicit signalling or by a UE capability associated with this processing.

A cell switch, as referred to herein, may comprise a procedure of triggering change of cells, for example via the LTM feature. Subsequent LTM may refer to a case where cell switch between L1/L2 mobility candidates is done without RRC configuration in between. A LTM configuration (LTM_config) may comprise one or more RRC configurations that includes LTM specific information elements. RRC ASN.1 validation may comprise validation of generic ASN.1 syntax and/or completeness validation. LTM evaluation (LTM_evaluation) may comprise UE 110 evaluating the LTM configuration and extracting information, for example one or more of the following: user plane configuration (e.g., change(s) required for MAC, RLC, PDCP, or SDAP), whether RF retuning is required after a cell switch command (LTM_switch_command), whether baseband retuning is required after a cell switch command (LTM_switch_command), or whether UE 110 is able to perform a RACH-less access procedure (e.g., by evaluating timing advance (TA) configuration). In response to evaluation of the LTM configuration, UE 110 may initiate preparations for further processes, such as a RACH-less access process to a target DU. LTM priority (LTM_priority) may comprise an indication of high priority for RRC-LTM configuration validation, processing, and/or preparation at UE 110. LTM uplink (UL) indication (LTM_UL_Indication) may indicate whether UE 110 is able to process the LTM configuration before the cell switch command. The LTM UL indication may indicate what parts of the RRC configuration are left for processing after the cell switch command LTM switch command (LTM_switch_command) may comprise a cell switch command, for example a MAC CE or DCI. LTM measurements (LTM_measurements) may comprise L1 or L3 handover measurements with or without an uplink indication.

One or more of the following performance enhancements may be targeted:
Security update may not need to be supported with L1/L2 based mobility.
ASN.1 decoding and validity/compliance check of candidate cell configuration may be performed upon reception of the candidate cells configuration.
For UE processing, the following (not exhaustive) operations may be performed after receiving the cell switch command: MAC/RLC reset (when configured), RF retuning (e.g. needed for inter-frequency), baseband retuning.
Performing DL synchronization to candidate/target cell before receiving the cell switch command, for example at least for the case that the target cell is already an active serving cell.
Support performing tracking reference signal (TRS) tracking and CSI measurement of candidate/target cell before/by cell switch command.

L1/L2-based mobility may be configured to support the following carrier aggregation (CA) scenarios: PCell (primary cell) change without SCell change or PCell change with SCell change. Furthermore, Support for NR-DC scenario in L1/L2-based mobility may be provided, at least for the case of PSCell (primary and secondary cells) change without master node (MN) involvement case, i.e., intra-SN (secondary node).

The following scenarios may be considered for L1 measurements and beam indication:
Event reporting or filtering may be supported.
Inter-frequency L1/L2 mobility: inter-frequency scenarios in general may be supported for L1/L2 mobility (including mobility to inter-frequency cell that is not a current serving cell), including the support of inter-frequency L1 measurements.
A unified TCI framework may be used for beam indication for L1/L2 mobility.

The following scenarios may be considered for dynamic cell switching:
L1/L2 mobility trigger information may be conveyed in a MAC CE. The MAC CE or DCI may be used for the actual triggering of the L1/L2 mobility.
MAC CE for L1/L2 mobility trigger may contain at least a candidate configuration index.
Performing SCell activation/deactivation (e.g., amongst SCells associated with the candidate configuration) simultaneously with L1/L2 mobility trigger MAC CE.
RACH-based (e.g., contention-free random access (CFRA), contention-based (CBRA)) and RACH-less procedures for L1/L2 mobility switch may be supported. RACH-less access may be used for example if the UE does not need to acquire timing advance (TA) during the cell switch.
RACH resource for CFRA for L1/L2 dynamic switch may be provided in RRC configuration or in a MAC CE.
The MAC CE may indicate TCI state(s) (or other beam info) to be activated for the target cell(s).
At L1/L2 cell switch: Whether the UE performs partial or full MAC reset, re-establishes RLC, performs data recovery with PDCP may be controlled by the network. This can be configured by RRC. Alternatively, or additionally, MAC CE indication(s) may be used.

It has been agreed that there is a capability of early ASN.1 decoding and validity check before cell switch to skip T_{LTM_RRC-processing} delay during the cell switch. When UE does not support this capability, the T_{LTM_RRC-processing} delay will not be skipped, and a value such as 10 ms (as currently defined) will be used. If the UE supports the capability, the value of T_{LTM_RRC-processing} may depend on the varying parameters.

There is a requirement to determine, when the UE supports the capability for early ASN.1 decoding and validity/compliance check, when and to which cells is the UE expected to perform this step. Presently, the network may end up transmitting the cell switch command too early to the UE, instead of providing UE enough time to perform the early ASN.1 validation and decoding. If this happens, the UE would need to do the validation and decoding step during the cell switch. From the network point of view, indeterministic cells switch delay causes reduced scheduling efficiency because the network is not able to predict when UE will connect to the target cell after the cell switch command is transmitted.

It is proposed herein to define clearly when the UE is expected to have performed early ASN.1 decoding and validity check of LTM RRC configuration for an LTM candidate cell after receiving the configuration. The proposed solutions include:
1. A definition of a trigger point at which the network can assume the UE has begun performing ASN.1 decoding and validity check for an LTM candidate cell after receiving the RRC configuration for this cell, and a related delay calculated starting from the trigger point to define point in time when the UE is expected to have completed performance of ASN.1 decoding and validity check for the LTM candidate cell. This trigger point is defined as a defined reference point related to at least one of: RRC configuration, TCI state activation command or PDCCH ordered RACH.
2. UE provides signaling to the network about a completed ASN.1 decoding and validity check after receiving the RRC configuration. The signaling can consider one or more LTM candidate cells in the configuration. This signaling can be in an additional indicator in any existing UL message.

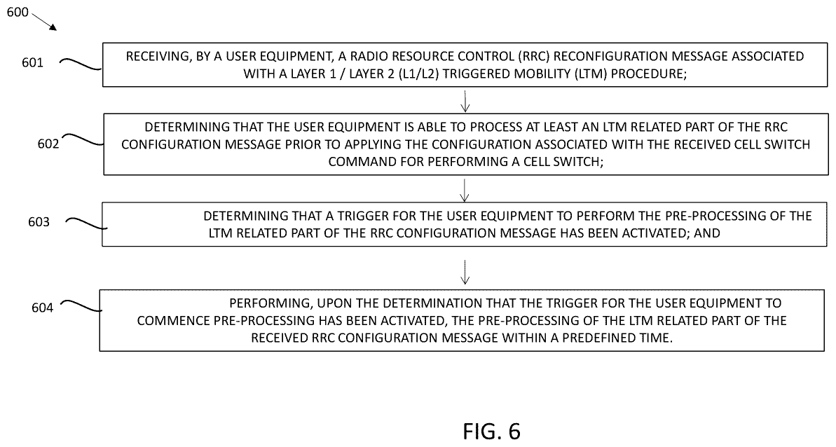

FIG. 6 shows, by way of example, a flowchart of a method according to example embodiments. Each element of the flowchart may comprise one or more operations. The operations may be performed in hardware, software, firmware or a combination thereof. For example, the operations may be performed, individually or collectively, by a means, wherein the means may comprise at least one processor; and at least one memory storing instructions that, when executed by the at least one processor, cause the performance of the operations.

The method 600 of FIG. 6 may be carried out by a UE, such as any of the UEs referred to herein.

The method 600 comprises a first operation 601 of receiving, by a UE, a radio resource control (RRC) reconfiguration message associated with a Layer 1/Layer 2 (L1/L2) triggered mobility (LTM) procedure.

The method 600 comprises a second operation 602 of means for means for determining that the user equipment is able to process at least an LTM related part of the RRC configuration message prior to applying the configuration associated with the received cell switch command for performing a cell switch. The processing of at least part of the L1/L2 LTM procedure may optionally include Abstract Syntax Notation One (ASN.1) validation and/or decoding.

The method 600 comprises a third operation 603 of determining that a trigger for the UE to perform the processing of the LTM related part of the RRC configuration message has been activated. The trigger may represent the start time for commencing the processing of the LTM related part of the received RRC configuration message. Upon commencing the processing of the LTM related part of the received RRC configuration message a short delay will ensue whilst it is completed. This is referred to as the processing time for completing the processing of the LTM related part of the receive RRC configuration message (i.e. LTM_RRC_processing).

The method 600 comprises a fourth operation 604 of performing, upon the determination that the trigger for the UE to commence processing has been activated, the processing of the LTM related part of the received RRC configuration message within a predefined time. Therefore, the processing of the LTM related part of the received RRC configuration message will be completed within a predefined time. The predefined time may comprise a processing time for completing the processing of the LTM related part of the received RRC configuration message. This may apply if there is no signaling to the network node that the processing of the LTM related part of the received RRC configuration message has been completed. The predefined time may comprise a time until an available signaling instant is available. This may apply if there is signaling to the network node that the processing of the LTM related part of the received RRC configuration message has been completed. In other words, when informing the network of the complete processing, a suitable signaling instant in the signaling procedure must be waited for.

The method 600 may optionally further comprise receiving, from a network node, a cell switch command for performing a cell switch from a source cell to a target cell and performing a cell switch from the source cell to the target cell.

The method 600 may optionally further comprise transmitting, to a network node, an indication that the processing of at least part of the L1/L2 LTM related part of the received RRC configuration message has been completed. The transmission of the indication that the processing has been completed may be sent at a predetermined time. The pre-determined time is linked to the trigger. For example, after a certain delay after the trigger it can be deemed that the processing is complete, and a message can accordingly be sent to a network node.

The trigger for the user equipment to commence the processing of the LTM related part of the RRC configuration message may be related to at least one of the following which will be discussed in turn:
1. RRC configuration (LTM candidate cell configuration)
2. Transmission configuration information (TCI) activation
3. PDCCH ordered RACH procedure
4. MAC CE

Processing delay is the delay of processing the associated command to resolve the LTM candidateId. CandidateId is used as an identifier to resolve which part of the ASN.1 configuration tree the UE will process.

In the case where UE processing delay is less than equal to ‘X’, where X is the worst case delay (minimum requirement) for T_{LTM-RRC-processing}. The UE shall indicate in one of the uplink messages it has performed early ASN.1 validation and decoding according to its capability.
The uplink message can be, for example MSG-5
UCI
UL in-band control element (such as MAC CE) carrying acknowledgement or information about transmission configuration information (TCI) activation, or successful RACH acquisition.

In one example the early decoding capability signaling is enhanced with a variable in which UE indicates (per UE type) how long the processing will take in maximum case.

### Trigger-RRC Configuration

The trigger for the UE to commence the processing of the LTM related part of the RRC configuration message may comprise the receipt, at the UE, of the RRC configuration message associated with the L1/L2 LTM procedure.

Alternatively, the trigger for the UE to commence the processing of the LTM related part of the RRC configuration message may comprise the transmission, from the UE, of an RRC configuration complete message associated with the L1/L2 LTM procedure.

In this option, the UE is expected to perform decoding and validity check for all the cells in the RRC configuration. This option is especially suitable for the case when there are not many candidate cells configured. This option may for example apply when the number of candidate cells in the RRC configuration in in the order of one or two. Alternatively, there may be predefined value of how many candidate cells UE processes from which UE selects one to process. The selection can be based on, for example RSRP threshold where candidates above or equal to a certain threshold will be processed as the threshold is reached.

The time when the UE is expected to be done with ASN.1 decoding and validity check is then taken from the trigger plus the required processing time for performing the processing, LTM_RRC_processing, where LTM_RRC_processing may be up to a predefined value N, for instance, N=10 ms as defined in the LTM cell switch delay, or may get a different value depending e.g. on UE capability or the number of cells in the RRC configuration.

### Trigger—Early TCI State Activation

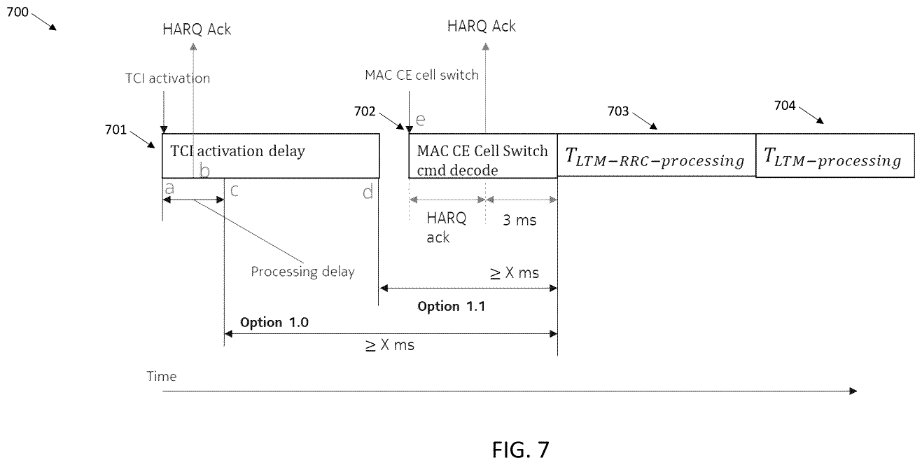

The trigger for the UE to commence the processing of the LTM related part of the RRC configuration message may relate to at least one element of a transmission configuration information (TCI) state activation procedure. By way of demonstration, an example TCI activation procedure 700 is shown in FIG. 7. The stages of the TCI activation procedure 700, as shown in FIG. 7, include TCI activation 701, MAC-CE Cell Switch 702, the LTM_RRC_processing 703 and LTM _processing 704.

In the case of TCI activation, there are many options to consider as the trigger for UE to commence the processing of the LTM related part of the RRC configuration message.

The trigger for the UE to commence the processing of the LTM related part of the RRC configuration message may comprise the receipt, at UE, of the TCI state MAC CE message. This is denoted by point ‘a’ in FIG. 7.

The trigger for the UE to commence the processing of the LTM related part of the RRC configuration message may comprise the transmission, from the UE, of an acknowledgement (e.g. HARQ ack) of the TCI state MAC CE message. This is denoted by point ‘b’ in FIG. 7.

The trigger for the UE to commence the processing of the LTM related part of the RRC configuration message may comprise the transmission, from the UE, of an acknowledgement (e.g. HARQ ack) of the TCI state MAC CE message in addition to a processing delay. This is denoted by point ‘c’ in FIG. 7.

The trigger for the UE to commence the processing of the LTM related part of the RRC configuration message may comprise the completion of the TCI state activation. In other words once the TCI state has been activated. This is denoted by point ‘d’ in FIG. 7.

Alternatively to any of the above described options, the UE can start the processing of the LTM related part of the RRC configuration message (i.e. early ASN.1 decoding and verification) at any or in between of the above points, as long as it is before cell switch MAC-CE command, which is denoted by point ‘e’ in FIG. 7. Normally, UE takes for example 10 ms to process LTM RRC. Upon these events, the network can assume that T_{ltm-RRC-processing}=Oms.

In this option, the UE performs the processing of the LTM related part of the RRC configuration message (i.e. the ASN.1 decoding and validity check) only for the candidate cell(s) for which TCI state is activated. This option is suitable when the number of candidate cells in the RRC configuration is large, and the UE is not capable to do the decoding and validity check for all the cells in the candidate cell configuration.

The time when the UE is expected to be done with the processing of the LTM related part of the RRC configuration message is then equal to the trigger plus T_LTM_RRC_processing, where T_LTM_RRC_processing may be up to 10 ms as defined in the LTM cell switch delay, or may get a different value depending e.g. on UE capability or the number of cells for which TCI state is activated (if done simultaneously).

### Trigger—PDCCH Ordered RACH Procedure

The trigger for the UE to commence the processing of the LTM related part of the RRC configuration message relates to at least one element of a physical downlink control channel (PDCCH) ordered random access channel (RACH) procedure.

If a PDCCH order is outside of the active bandwidth part (BWP), the UE is allowed to have extra time for baseband retuning. Furthermore, the UE may be configured to perform PDCCH orders to one or more target cells. Therefore, the time UE knows the PDCCH order is useful, is when the PDCCH order is successful. This may be one of the reasons why the reference point associated with T_LTM-RR-processing that is related the PDCCH order can be once UE knows that the PDCCH order is successful.

The trigger for the UE to commence the processing of the LTM related part of the RRC configuration message may comprise the receipt, at the user equipment, of a downlink control information (DCI) command.

The trigger for the UE to commence the processing of the LTM related part of the RRC configuration message may comprise the receipt, at the user equipment, of the DCI command and processing delay associated with decoding delay for the candidateId.

The trigger for the UE to commence the processing of the LTM related part of the RRC configuration message may comprise the receipt, at the user equipment, of the DCI command and processing delay associated with decoding delay for the candidateId and a first RF retuning and optionally processing delay. An RF retuning delay is the delay that it takes for UE to retune RF towards the target cell in LTM cell switch. It may also include some UE scripts this includes preparation.

The trigger for the UE to commence the processing of the LTM related part of the RRC configuration message may comprise the receipt, at the user equipment, of the DCI command and processing delay associated with decoding delay for the candidateId and a first retuning delay and a successful RACH.

The trigger for the UE to commence the processing of the LTM related part of the RRC configuration message may comprise the receipt, at the user equipment, of the DCI command and processing delay associated with decoding delay for the candidateId and a first RF retuning and optionally processing delay and a successful RACH and second tuning delay.

The trigger for the UE to commence the processing of the LTM related part of the RRC configuration message may comprise the completion of the physical downlink control channel (PDCCH) ordered random access channel (RACH) procedure.

Alternatively to any of the above described options, the UE can start the processing of the LTM related part of the RRC configuration message (i.e. early ASN.1 decoding and verification) at any or in between of the above points.

In this option, the UE performs the processing of the LTM related part of the RRC configuration message (e.g. the ASN.1 decoding and validity check) only for the candidate cell(s) for which it receives PDCCH order. This option is suitable when the number of candidate cells in the RRC configuration is large, and the UE is not capable to do the decoding and validity check for all the cells in the candidate cell configuration.

The time when the UE is expected to be done with the processing of the LTM related part of the RRC configuration message is then equal to the trigger T_LTM_RRC_processing, where T_LTM_RRC_processing may be up to N ms where, N is, for example 10 ms as defined in the LTM cell switch delay, or may get a different value depending e.g. on UE capability or configuration.

If UE completes the processing of the LTM related part of the RRC configuration message before MSG 5, UE can inform gNB of the completion in any of the UL messages during RACH. We propose to include an indicator in any of the UL message during RACH for early TA acquisition via PDCCH order. If UE complete the early ASN,1 after MSG5 and even after UE retunes back from target cell to the serving cell, UE will inform gNB about the completion in the next available opportunities.

### Trigger—MAC CE Cell Switch

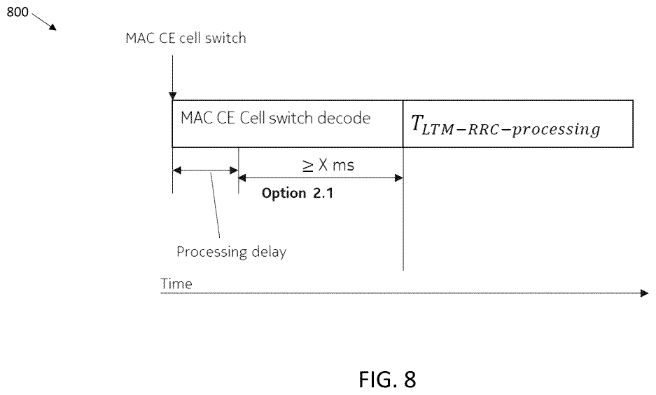

The trigger for the UE to commence the processing of the LTM related part of the RRC configuration message relates to a MAC CE cell switch procedure 800 as shown in FIG. 8. The cell switch may also be considered as the trigger point for commencing the processing of the LTM related part of the RRC configuration message. In other words, the =trigger for the UE to commence the processing of the LTM related part of the RRC configuration message may comprise the MAC CE switch command decoding

This scenario is especially beneficial, if UE can do the processing of the LTM related part of the RRC configuration message in a very short time (e.g. 1-2 ms). The UE may proceed with the following steps:
Decode candidateId from the cell switch MAC CE
After successful decoding, start parallel processing of the processing of the LTM related part of the RRC configuration message.
Finish the T_{LTM-RRC-processing} before the minimum requirements (worst case) delay budget has run out.
Resulting that T_{LTM-RRC-processing} is 0.

For example, minimum requirements for MAC CE processing are 5 ms. UE performs reception and decoding of the MAC CE in 2 ms and processing of the LTM related part of the RRC configuration message for the candidateId takes 1 ms, hence UE has still 2 ms left of MAC CE minimum requirements budget. Therefore, the T_{LTM-RRC-processing} is 0 in this case. The values can be indicated as dynamic capability or signaled to the network e.g. via an indication to the network.

The options above may be used separately, and they can also be combined in any way, for example, if the number of candidate cells in RRC configuration is not larger than 1, then the UE is expected to have performed ASN.1 decoding and validity check at the time of RRC configuration complete+T_LTM_RRC_processing. Otherwise, if TCI state is activated for a candidate cell in RRC configuration before the cell switch command at slot n, the UE is expected to have performed ASN.1 decoding and validity check at the time of n+T_{HARQ}+3Nₛₗₒₜ^{subframe,μ}+T_LTM_RRC_processing. Otherwise, if UE receives PDCCH order for a slot candidate cell in RRC configuration before the cell switch command at slot n, the UE is expected to have performed ASN.1 decoding and validity check at the time of n+T_LTM_RRC_processing. Otherwise, the UE is allowed time to perform ASN.1 decoding and validity check for the target cell in LTM cell switch command during the cell switch delay.

The benefit of proposed solution using a ‘trigger point’ in defining when the UE is expected to have completed the ASN.1 decoding and validity check is that no new signaling is needed and faster signaling process can be achieved.

### Introduction of Signaling

The method 600 of FIG. 6 may optionally further comprise transmitting, to a network node, an indication that the processing of at least part of the L1/L2 LTM related part of the received RRC configuration message has been completed.

When new signaling is introduced, the UE is able to tell the network exactly when it has completed the early ASN.1 decoding and validity check.

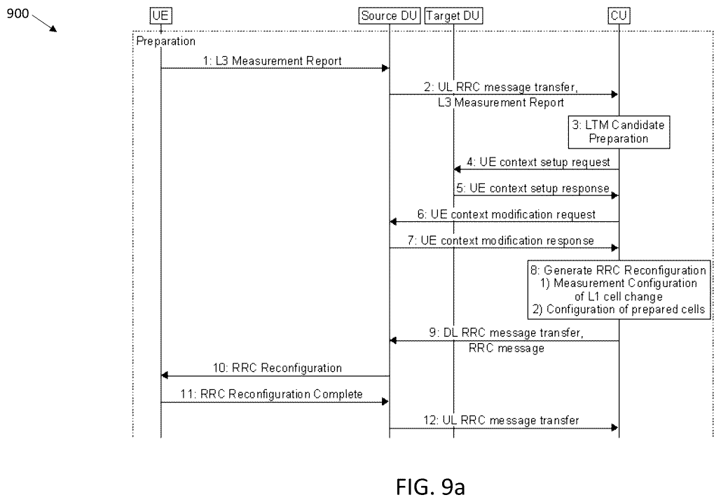

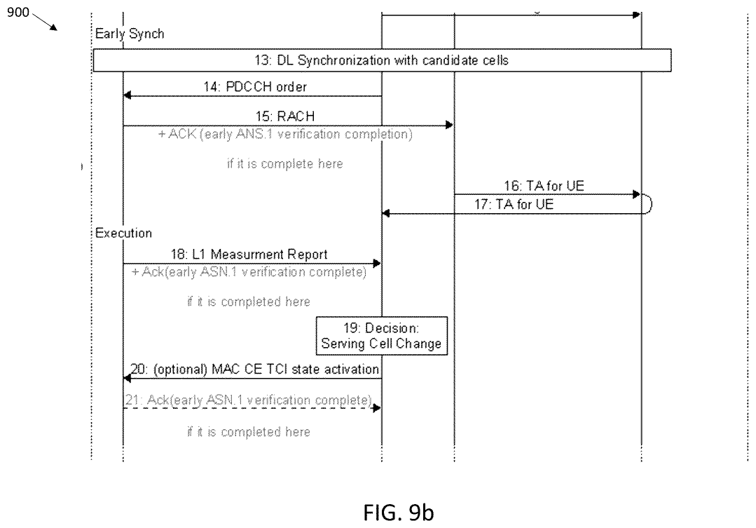

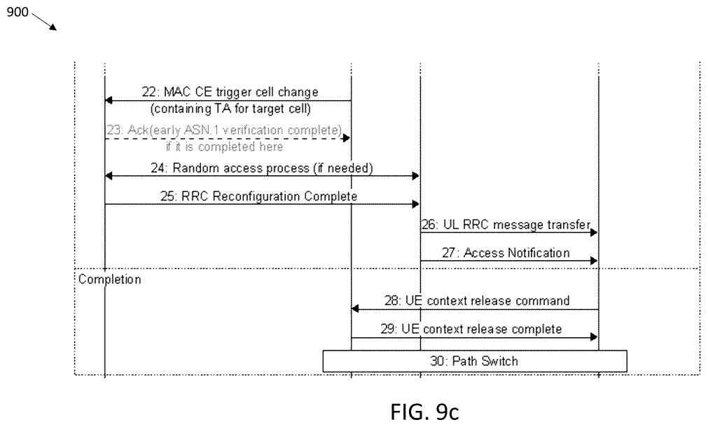

FIGS. 9A-9C show an example UE signaling flow chart 900 which shows examples of when the new signaling can be introduced into the signaling procedure to inform the network node that the processing of at least part of the L1/L2 LTM related part of the received RRC configuration message has been complete. At step 1, the UE sends an L3 measurement report to the source DU and Target DU. In steps 2 to 9, the source and target DU communication with the CU to generate an RRC configuration. At steps 10 and 11 the RRC configuration is completed at the UE. Next the various steps of a signaling procedure for cell switching are shown, including RRC configuration, TCI state activation, MAC-CE or PDCCH order and how the indication that the processing of at least part of the L1/L2 LTM related part of the received RRC configuration message has been completed may be integrated into the signaling procedure.

The signaling may be introduced in the existing signaling, for example some options are highlighted below and shown in FIGS. 9A-9C are:
ACK/NACK related to RRC configuration, TCI state activation, MAC-CE or PDCCH order. For example, step 15 shows the early ASN.1 verification complete message sent alongside the PDCCH order, step 21 shows the early ASN.1 verification complete message sent alongside the TCI state activation and step 23 shows the early ASN.1 verification complete message sent alongside the MAC CE trigger cell change.
UE assistance information (not shown in FIGS. 9A-9C)
L1 or L3 measurement report. For example, step 18 of FIG. 9A-C shows the early ASN.1 verification complete message sent alongside the L1 measurement report.
New type of signal (e.g. RRC or MAC-CE based). A new independent signal may be introduced which does not relate to any already present signal.

The signaling may consider all or a subset of the configured LTM candidate cells. Hence, the signaling may indicate for which cells the UE has performed the decoding and validity check step.

The UE may be required to perform the ASN.1 decoding and validity check triggered by RRC configuration, TCI state activation or PDCCH order, but the UE will inform with new signaling when exactly this step is completed. Signaling may also be implemented for the case when early ASN.1 decoding and validity check before cell switch is up to UE implementation and is not required to be done based on any trigger.

From requirement and testing point of view, if some message is expected to trigger early ASN.1 decoding and validity check for one or more LTM candidate cells, the UE may be required to send the indication about completed decoding and validity check for one or more candidate cells by a certain time instant. This time instant may be defined to be the same as the trigger for performing the processing of the LTM related part of the RRC configuration message or based on available signaling occasions. The UE may send the indication before or latest at the defined time instant. There may also be no requirement for when the signaling is sent if performing the decoding and validity check is up to UE implementation.

When the UE has indicated to the network before cell switch that early ASN.1 decoding and validity check is completed for the target cell in the LTM cell switch command, the UE is not given time for this step during the cell switch i.e. T_LTM_RRC_processing=0 in the cell switch delay requirement. If the UE has not sent this indication for the target cell in the cell switch command, UE is allowed to do ASN.1 decoding and validity check during the cell switch, and T_LTM_RRC_processing gets a value different from 0, e.g. 10 ms.

The benefits of using this signaling mean that it is left up to UE implementation when exactly to start the decoding and validity check, and signaling allows different durations for this step, which is useful as different UEs may require different times for this step.

### Network Node Perspective

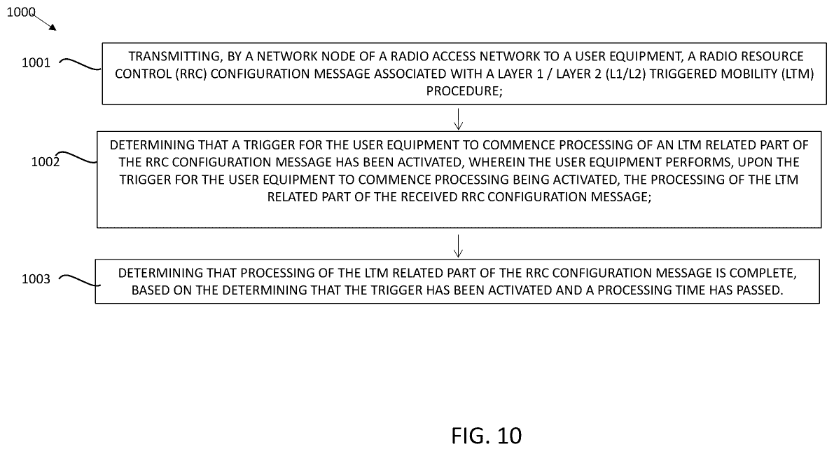

FIG. 10 shows, by way of example, a flowchart of a method according to example embodiments. Each element of the flowchart may comprise one or more operations. The operations may be performed in hardware, software, firmware or a combination thereof. For example, the operations may be performed, individually or collectively, by a means, wherein the means may comprise at least one processor; and at least one memory storing instructions that, when executed by the at least one processor, cause the performance of the operations.

The method 1000 of FIG. 6 may be carried out by a network node of radio access network, such as any of the network nodes or gNBs described herein.

The method 1000 includes a first operation 1001 of transmitting, by a network node of a radio access network to a user equipment, an RRC configuration message associated with a L1/L2 LTM procedure. This RRC configuration message is received by a UE as previously discussed herein in relation to FIG. 6.

The method 1000 includes a second operation 1002 of determining that a trigger for the UE to commence the processing of the LTM related part of the RRC configuration message has been activated. The UE performs, upon the trigger for the user equipment to commence processing has been activated, the processing of the LTM related part of the received RRC configuration message. The trigger may be noted at the UE in accordance with any of the embodiments previously discussed herein.

The method 1000 includes a third operation 1003 of determining that processing of the LTM related part of the RRC configuration message is complete, based on the determining that the trigger has been activated and a processing time has passed.

The benefit of this approach is that the network knows based on how the trigger plus a defined processing delay, when to send the cell switch command to get a shorter cell switch delay. Before the time for trigger plus processing time the cell switch delay can be assumed to be longer. Therefore, the network has the benefit of knowing when the message is sent and can plan accordingly for when to order the cell switch.

The method 1000 may optionally further comprise receiving, from the UE, an indication that the processing of at least part of the L1/L2 LTM related part of the received RRC configuration message has been completed.

Implementations of any of the above described blocks, apparatuses, systems, techniques or methods include, as non-limiting examples, implementations as hardware, software, firmware, special purpose circuits or logic, general purpose hardware or controller or other computing devices, or some combination thereof. Some embodiments may be implemented in the cloud.

It is to be understood that what is described above is what is presently considered the preferred embodiments. However, it should be noted that the description of the preferred embodiments is given by way of example only and that various modifications may be made without departing from the scope as defined by the appended claims.

1. An apparatus, comprising:
at least one processor; and at least one memory storing instructions that, when executed by the at least one processor, cause the apparatus to perform:
receiving, by a user equipment, a radio resource control (RRC) configuration message associated with a Layer 1/Layer 2 (L1/L2) triggered mobility (LTM) procedure;
determining that the user equipment is able to process at least an LTM related part of the RRC configuration message prior to applying the configuration associated with the received cell switch command for performing a cell switch;
determining that a trigger for the user equipment to perform the processing of the LTM related part of the RRC configuration message has been activated; and
performing, upon the determination that the trigger for the user equipment to commence processing has been activated, the processing of the LTM related part of the received RRC configuration message within a predefined time.

2. The apparatus of claim 1, wherein the apparatus is further caused to perform:
receiving, from a network node, a cell switch command for performing a cell switch from a source cell to a target cell; and
performing a cell switch from the source cell to the target cell.

3. The apparatus of claim 1, wherein the processing of at least part of the L1/L2 LTM procedure comprises Abstract Syntax Notation One (ASN.1) validation and/or decoding.

4. The apparatus of claim 1, wherein the trigger represents the start time for commencing the processing of the LTM related part of the received RRC configuration message, and the processing of the LTM related part of the received RRC configuration message will be completed at the user equipment after a processing time.

5. The apparatus of claim 1, wherein the trigger for the user equipment to commence the processing of the LTM related part of the RRC configuration message comprises:
the receipt, at the user equipment, of the RRC configuration message associated with the L1/L2 LTM procedure; or
the transmission, from the user equipment, of an RRC configuration complete message associated with the L1/L2 LTM procedure.

6. The apparatus of claim 1, wherein the trigger for the user equipment to commence the processing of the LTM related part of the RRC configuration message relates to at least one element of a transmission configuration information (TCI) state activation procedure.

7. The apparatus of claim 6, wherein the trigger for the user equipment to commence the processing of the LTM related part of the RRC configuration message comprises:
the receipt, at the user equipment, of a transmission configuration information (TCI) state activation medium access control (MAC) control element (CE) message.

8. The apparatus of claim 6, wherein performing the processing of the LTM related part of the received RRC configuration message comprises performing the processing of only for the candidate cell(s) for a TCI state to be activated.

9. The apparatus of claim 1, wherein the trigger for the user equipment to commence the processing of the LTM related part of the RRC configuration message relates to at least one element of a physical downlink control channel (PDCCH) ordered random access channel (RACH) procedure.

10. The apparatus of claim 9, wherein the trigger for the user equipment to commence the processing of the LTM related part of the RRC configuration message comprises:
the receipt, at the user equipment, of a downlink control information (DCI) command; or
the completion of the physical downlink control channel (PDCCH) ordered random access channel (RACH) procedure.

11. The apparatus of claim 1, wherein the apparatus is further caused to perform:
transmitting, to a network node, an indication that the processing of at least part of the L1/L2 LTM related part of the received RRC configuration message has been completed.

12. The apparatus of claim 11, wherein the transmission of the indication that the processing has been completed is sent at a predetermined time.

13. The apparatus of claim 1, wherein the apparatus comprises the user equipment.

14. An apparatus, comprising
at least one processor; and at least one memory storing instructions that, when executed by the at least one processor, cause the apparatus to perform:
transmitting, by a network node of a radio access network to a user equipment, a radio resource control (RRC) configuration message associated with a Layer 1/Layer 2 (L1/L2) triggered mobility (LTM) procedure;
determining that a trigger for the user equipment to commence processing of an LTM related part of the RRC configuration message has been activated, wherein the user equipment performs, upon the trigger for the user equipment to commence processing has been activated, the processing of the LTM related part of the received RRC configuration message;
determining that processing of the LTM related part of the RRC configuration message is complete, based on the determining that the trigger has been activated and a processing time has passed.

15. The apparatus of claim 14, wherein the apparatus is further caused to perform:
transmitting, from a network node to the user equipment, a cell switch command for performing a cell switch from a source cell to a target cell.

16. The apparatus of claim 14, wherein the processing of at least part of the L1/L2 LTM procedure comprises Abstract Syntax Notation One (ASN.1) validation and/or decoding.

17. The apparatus of claim 14, wherein the trigger represents the start time for commencing the processing of the LTM related part of the received RRC configuration message at the user equipment, and the processing of the LTM related part of the received RRC configuration message will be completed at the user equipment after a processing time.

18. The apparatus of claim 14, wherein the trigger for the user equipment to commence the processing of the LTM related part of the RRC configuration message comprises:
the receipt, at the user equipment, of the RRC configuration message associated with the L1/L2 LTM procedure; or
the transmission, from the user equipment, of an RRC configuration complete message associated with the L1/L2 LTM procedure.

19. The apparatus of claim 14, wherein the trigger for the user equipment to commence the processing of the LTM related part of the RRC configuration message relates to at least one element of a transmission configuration information (TCI) state activation procedure.

20. The apparatus of claim 19, wherein the trigger for the user equipment to commence the processing of the LTM related part of the RRC configuration message comprises:
the receipt, at the user equipment, of a transmission configuration information (TCI) state activation medium access control (MAC) control element (CE) message; or
the transmission, from the user equipment, of an acknowledgement of the transmission configuration information (TCI) state activation medium access control (MAC) control element (CE) message; or
the transmission, from the user equipment, of an acknowledgement of the transmission configuration information (TCI) state activation medium access control (MAC) control element (CE) message in addition to a processing delay; or
the completion of a transmission configuration information (TCI) state activation.
